(19) United States
(12) Patent Application Publication
(10) Pub. No.: US 2002/0026286 A1
(43) Pub. Date: Feb. 28, 2002

(54) System for material testing machine

(75) Inventor: Takefumi Kawasaki, Kyoto-shi (JP)

Correspondence Address: KANESAKA AND TAKEUCHI, 1423 Powhatan Street, Alexandria, VA, 22314, US

(73) Assignee: Shimadzu Corporation

(21) Appl. No.: 09/922,780

(22) Filed: Aug. 7, 2001

(30) Foreign Application Priority Data
Aug. 22, 2000 (JP) 2000-250690

(51) Int. Cl. G01L 1/00; G01L 3/00; G01L 5/00; G06F 19/00

(52) U.S. Cl. 702/41

(57) ABSTRACT

In a system for a material testing machine, a computer attached to a material testing machine is connected to an outside provider, and test information by the material testing machine is periodically sent from the computer to a web site to update the information. By accessing the web site from any cellular phone or another personal computer, test status or test result by the material testing machine can be checked at any place. Accordingly, without forming a large-scaled system, the test status or the like by the material testing machine can be obtained while an operator is far away from the material testing machine.

### BACKGROUND OF THE INVENTION AND RELATED ART STATEMENT

The present invention relates to a system including a material testing machine, and more specifically, it relates to a system for a material testing machine by which information regarding tests can be checked at a location away from a place where a material testing machine is placed.

In a material testing machine, in general, while a load is applied to a test piece, a state of the load is continuously detected by a load cell or the like, and at the same time, a change of state, such as a distortion of the test piece by the load is detected continuously by a distortion gauge. Normally, the detected result is sequentially subjected to data-processing by an attached personal computer, and processed data is displayed at a display of the personal computer as the momentary test result, or printed out by a printer connected to the personal computer.

Also, conventionally, there has been a system in which respective personal computers of a plurality of material testing machines are connected online to a host computer, wherein data of test results processed in the respective personal computers is transmitted to the host computer such that the host computer manages the data.

According to the conventional material testing machine as described above, in the material testing machine which is not connected to the host computer, there is a problem that one must be always present near the material testing machine in order to know the test status by the material testing machine.

Also, even in case of connecting to the host computer, it is necessary to structure a large-scaled online system if a location of the material testing machine is different from a location of the host computer, resulting in requiring an enormous cost.

The present invention has been made in view of the foregoing, and an object of the invention is to provide a material testing machine system having a simple structure, in which an operator is able to know a test status by the material testing machine while the operator is at a place far away from the material testing machine.

Further objects and advantages of the invention will be apparent from the following description of the invention.

### SUMMARY OF THE INVENTION

To achieve the aforementioned object, a first aspect of the present invention provides a system for a material testing machine comprising a material testing machine, which includes a load mechanism for applying a load to a test piece; a group of sensors for detecting information regarding a load by driving the load mechanism and information regarding a condition of the test piece in accordance with the load; and a computer for receiving outputs from the group of sensors and processing data to thereby obtain the test information. The computer is connected to an outside provider, and set to update the test information periodically to a web site established in the outside provider. The updated test information in the web site can be obtained at any time from other computers or portable terminals.

Also, a second aspect of the invention provides a system for a material testing machine comprising a material testing machine, which includes a load mechanism for applying a load to a test piece; a group of sensors for detecting information regarding a load by driving the load mechanism and information regarding a condition of the test piece in accordance with the load; and a computer for receiving outputs from the group of sensors and processing data to thereby obtain test information. The computer is connected to an outside provider and set to periodically send the test information by an electronic mail to a control computer disposed independently and connected to the outside provider.

Further, a third aspect of the invention provides a system for a material testing machine comprising a material testing machine, which includes a load mechanism for applying a load to a test piece; a group of sensors for detecting information regarding a load by driving the load mechanism and information regarding a condition of the test piece in accordance with the load; and a computer for receiving outputs from the group of sensors and processing data to thereby obtain test information. The computer is connected to an outside provider and set to periodically send the test information by an electronic mail to a terminal disposed independently and connected to the outside provider.

In the present invention, the computer attached to the material testing machine is connected to the outside provider such that the test status by the material testing machine can be obtained through the internet or the electronic mail, to thereby achieve the object of the invention.

Namely, in the system for the material testing machine according to the first aspect of the invention, the computer attached to the material testing machine is connected to the outside provider, and at the same time, the test status or test result by the material testing machine is periodically sent to the web site established in advance, to update these contents. Therefore, when the web site is opened by using any portable terminals, such as cellular phones, or any personal computers disposed at a different location, the test status or test result or the like by the material testing machine can be obtained at any places.

Also, in the system for the material testing machine according to the second aspect of the invention, the computer attached to the material testing machine is connected to the outside provider, and the test information is periodically sent to the control computer by the electronic mail. According to this structure, even if the control computer is located at a place far away from the material testing machine, without forming the large-scaled online system, the test information by the material testing machine can be periodically obtained at the control computer.

In the system for the material testing machine according to the third aspect of the invention, the computer attached to the material testing machine is connected to the outside provider, and the test information is sent to the specific portable terminal, such as a cellular phone, or the specific terminal, such as a specific personal computer disposed separately and independently, by the electronic mail. Therefore, the test information by the material testing machine is periodically updated at the specific portable terminal or the like, so that the current test information can be obtained at the portable terminal or the like.

### BRIEF DESCRIPTION OF THE DRAWINGS

FIG. 1 is a schematic explanatory view for showing a structure of a first embodiment of the invention;

FIG. 2 is a schematic explanatory view for showing a structure of a second embodiment of the invention; and

FIG. 3 is a schematic explanatory view for showing a structure of a third embodiment of the invention.

### DETAILED DESCRIPTION OF PREFERRED EMBODIMENTS

Hereinafter, embodiments of the invention will be explained with reference to the attached drawings.

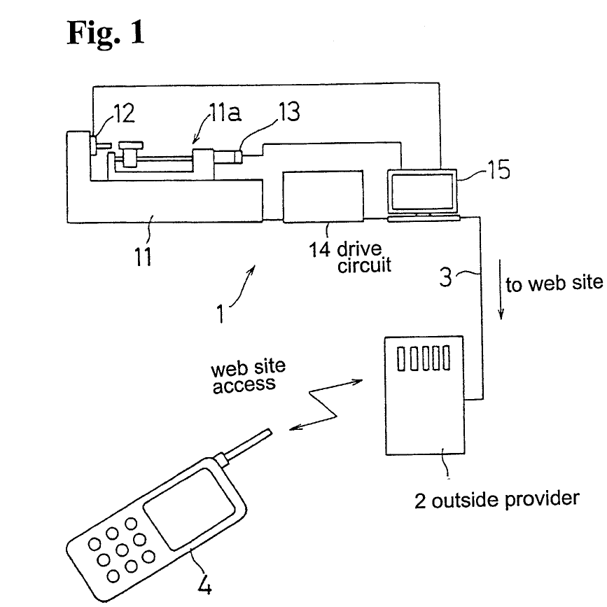

FIG. 1 is a structural view showing a structure of a first embodiment according to the invention.

A material testing machine 1 has a testing machine main body 11 including a load mechanism 11a, and a personal computer 15 which momentarily receives outputs from a group of sensors, such as a load cell 12 and a displacement sensor 13 respectively provided in the testing machine main body 11, through an amplifier and an analog-to-digital converter, not shown. Also, the personal computer 15 controls a drive circuit 14 for driving the load mechanism 11a. The personal computer 15 is connected to an outside provider 2 by a telephone line 3, or LAN (local area network).

In the outside provider 2, an exclusive web site is established in advance, and the personal computer 15 of the material testing machine 1 is programmed to send test information by the material testing machine 1 periodically and to update contents thereof. Therefore, by using any portable terminals including a cellular phone 4 or any personal computer disposed at any place, the web site is accessed through an internet, so that the current test status or test result by the material testing machine 1 can be checked at any time. Also, based on the checked contents, an instruction of discontinuing the test or the like can be sent to the personal computer 15 in the material testing machine 1 by using an electronic mail.

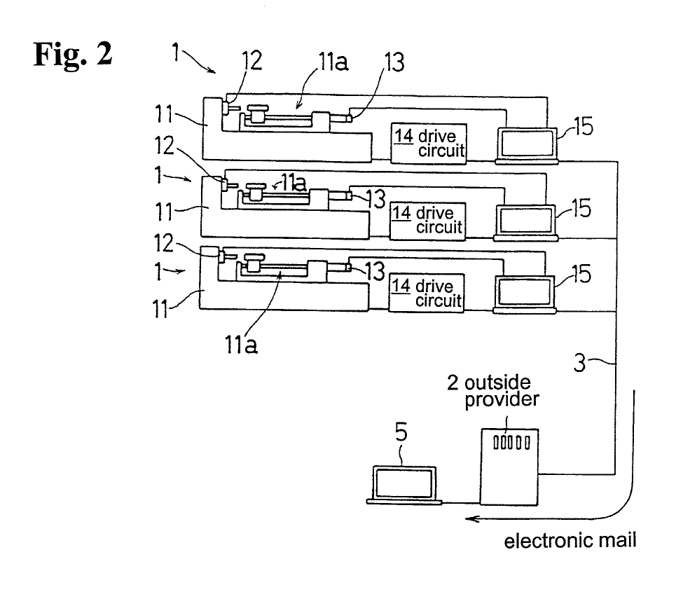

Next, a second embodiment of the invention will be explained. FIG. 2 is a structural view showing the second embodiment.

In this embodiment, respective personal computers of a plurality of material testing machines 1 having the same structure as in the first embodiment are connected to the outside provider 2 by the respective telephone lines 3 or LAN. Also, apart from these personal computers 15, a control computer 5 is connected to the same outside provider 2, and the personal computers 15 of the respective material testing machines 1 are set to periodically send respective test information to the control computer 5 by e-mails. Therefore, the respective test information of the plurality of material testing machines 1 is periodically collected at the control computer 5, so that the control computer 5 can manage these information and carry out data processing, such as statistical processing.

Also, in this embodiment of the invention, the instructions regarding the test or operation can be sent from the control computer 5 to the personal computers 15 of the respective material testing machines 1 through e-mails, and in response to these instructions, the respective personal computers 15 can be operated to control the respective material testing machines 1.

Furthermore, by using the control computer 5 as a server, the control computer 5 can be connected from the portable terminal or other personal computer through the internet, so as to know the test information by the respective material testing machines 1 from any place.

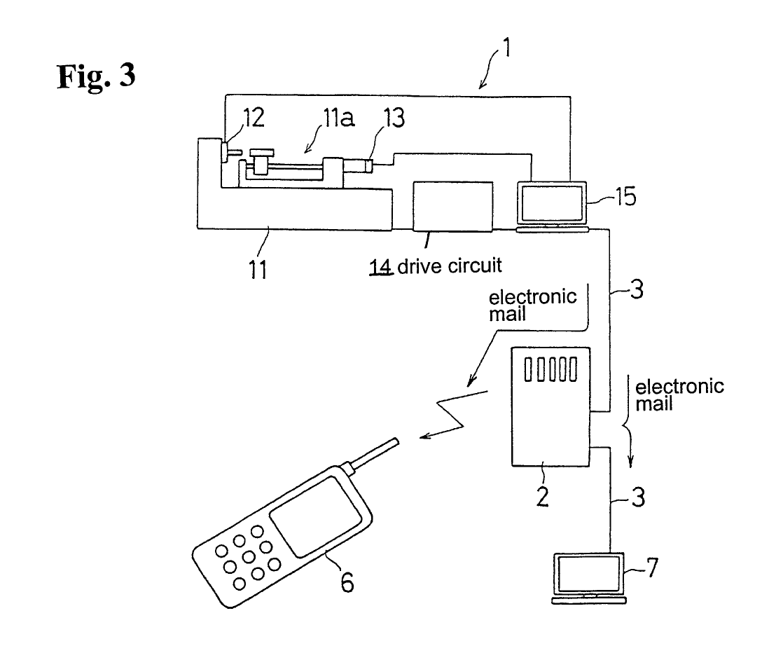

Next, the third embodiment of the invention will be explained. FIG. 3 is a structural view showing the third embodiment.

In this embodiment, the personal computer 15 of the material testing machine 1 having the same structure as in the aforementioned embodiments is connected to the outside provider 2 by the telephone line 3 or LAN. Then, the personal computer 15 periodically sends the test information by the material testing machine 1 to a specific cellular phone 6 or a separately disposed, specific personal computer 7, which is specified in advance, through e-mails. Therefore, according to the third embodiment, by using the specific cellular phone 6 or the specific personal computer 7, the test information by the material testing machine 1 can be obtained.

Also, in this embodiment, by adopting an attachment format, image data, such as a load-elongation curve, can be sent, and in this case, the test status or condition by the material testing machine 1 can be checked by the image by using the portable terminal.

As described above, according to the first aspect of the invention, since the test information by the material testing machine is updated periodically from the computer attached to the material testing machine to the web site established in the outside provider, by connecting the web site from any cellular phone or any personal computer through the internet at any time, the operator is able to know the current test status or test result by the material testing machine from any place without being present near the material testing machine. Especially, in case of a test which takes long time, or in case of using an automatic material testing machine, since test information can be obtained when necessary, contact or communication in case of an error, or contact regarding an end of the test become available.

Also, according to the second aspect of the invention, since the test information by the material testing machines is periodically sent to the control computer from the personal computers attached to the material testing machines, irrespective of the installed location of the control computer, the data management for the plurality of material testing machines can be carried out by the control computer without forming the large-scaled online system. Moreover, on the contrary, the instructions in response to the operation ratio of the respective material testing machines and test results thereof can be carried out by the control computer.

Furthermore, according to the third aspect of the invention, since the test information can be sent by e-mail from the personal computer attached to the material testing machine to the specific portable terminal or the specific personal computer through the outside provider, the operator can check the test information without being present near the material testing machine. In case of the test requiring a long time or using the automatic material testing machine, the test information can be obtained when necessary, so that the operator can contact at the time of an error or the end of the test while the operator is far away from the material testing machine.

While the invention has been explained with reference to the specific embodiments of the invention, the explanation is illustrative and the invention is limited only by the appended claims.

What is claimed is:

1. A system for a material testing machine, comprising:
a material testing machine having a load mechanism for applying a load to a test piece, sensors for detecting information regarding a load caused by the load mechanism and information regarding a condition of the test piece in accordance with the load, and a computer electrically connected to the sensors for receiving outputs from the sensors and processing data to thereby obtain test information,
an outside provider electrically connected to the computer, and
information means electrically connected to the outside provider for receiving outputs of the computer through the outside provider.

2. A system for a material testing machine according to claim 1, wherein said information means is a web site established in the outside provider, and said computer is set to update the test information periodically to the web site, said web site including updated test information accessible at any time from another computer or a portable terminal.

3. A system for a material testing machine according to claim 1, wherein said information means is a control computer disposed independently and connected to the outside provider, said computer being set to periodically send the test information by an electronic mail to the control computer.

4. A system for a material testing machine according to claim 3, further comprising another material testing machine having a load mechanism for applying a load to a test piece, sensors for detecting information regarding a load caused by the load mechanism and information regarding a condition of the test piece in accordance with the load, and another computer electrically connected to the sensors of the another material testing machine for receiving outputs from the sensors and processing data to thereby obtain test information, said another computer being electrically connected to the control computer to periodically send the test information by an electronic mail to the control computer.

5. A system for a material testing machine according to claim 1, wherein said information means is a terminal disposed independently and connected to the outside provider, said computer being set to periodically send the test information by an electronic mail to the terminal.
